(19) United States
(12) Patent Application Publication
(10) Pub. No.: US 2002/0169607 A1
(43) Pub. Date: Nov. 14, 2002

(54) Speech recognition device

(76) Inventors: Yoshikazu Miyanaga, Sapporo-shi (JP); Masayuki Kabasawa, Tokyo (JP)

Correspondence Address: KENYON & KENYON, 1500 K STREET, N.W., SUITE 700, WASHINGTON, DC, 20005, US

(21) Appl. No.: 10/026,524

(22) Filed: Dec. 27, 2001

(30) Foreign Application Priority Data
Mar. 21, 2001 (JP) 2001-081311

(51) Int. Cl. G10L 15/12; G10L 15/08; G10L 15/00

(52) U.S. Cl. 704/238

(57) ABSTRACT

The speech recognition device, which can realize speech recognition with a small-scaled circuit, has been disclosed. The speech recognition device comprises the similarity circuit, which receives speech input signals and puts out characteristics based on the self-organizing algorithm, and the matrix circuit that performs the matrix operations of the output signal, wherein: the similarity circuit comprises a circuit that calculates distances between plural multi-dimensional input vectors and the pattern vectors prepared in advance, calculates a value corresponding to one dimension using a pair of neuron MOSFETS, and forms a voltage signal in accordance with the degree of similarity by summing up the current that flows in each neuron MOSFET; and the matrix circuit, in which capacitors corresponding to weighting operations are arranged in matrix, receives a voltage signal in accordance with the degree of similarity and outputs what is most similar, to the patterns prepared in advance.

### BACKGROUND OF THE INVENTION

The present invention relates to a speech recognition device. More particularly, the present invention relates to semiconductor integrated circuits to perform speech recognition.

In recognizing speech and images, clustering and labeling are basic processes, and self-organizing clustering has been proposed in reference document 1 and a clustering system employing a learning method with a teacher has been proposed in reference document 2 and reference document 3. The reference documents are described below. Speech recognition using this system has also been reported. Although parallel processing digital LSIs to perform the self-organizing clustering process at a high speed have been proposed, a problem, that the area of chips is increased in a parallel processing system, occurs. As analog circuits that can calculate distance, and can be realized with a small number of devices, a circuit that uses neuron MOSFETs and calculates a Manhattan distance has been proposed in reference document 4, and that which puts out the square of an Euclidean distance has been proposed in reference document 5.

Reference document 1 is, Y. Miyanaga, S. Okumura, and K. Tochinai, [On versatility and adaptability of self-organizing clustering] Electronic Information/Communication Conference (A), vol. J75-A, no. 7, pp. 1207-1215, July 1992.

Reference document 2 is, Y. Miyanaga and K. Tochinai, [On high speed and high accurate learning of network by self-organization and teacher] Electronic Information/Communication Conference (A), vol. J78-A, no. 11, pp.1475-1484, November 1995.

Reference document 3 is, R. Islam, Y. Miyanaga, and K. Tochinai, [Multi-clustering network for data classification system] IEICE Trans. Fundamentals, vol. E80-A, no. 9, pp. 1647-1654, September 1997.

Reference document 4 is, M. Konda, T. Shibata, and T. Ohmi, [Neuron-MOS correlator based on Manhattan distance computation for event recognition hardware] IEEE International Symposium on Circuit and Systems, vol. 4, Atlanta, USA, pp. 217-220, May 1996.

Reference document 5 is, U. Cilingiroglu and D. Y. Aksin, [A 4-transistor Euclidean distance cell for analog classifiers] IEEE International Symposium on Circuits and Systems, vol. 1, California, USA, pp. 84-87, May 1998.

The present applicants have examined the parallel operation processing digital LSI using the above-mentioned speech recognition art, but have been confronted with a problem in that the number of basic operation modules becomes very large and the chip area of integrated circuit becomes large. Therefore, while aiming at reduction in circuit scale, the applicants have tried to realize clustering and labeling, which are basic processes in the above-mentioned speech and image recognition, in analog circuits.

### SUMMARY OF THE INVENTION

The object of the present invention is to provide a speech recognition device that can realize speech recognition using a small-scale circuit. The other object of the present invention is to provide a speech recognition device appropriate to semiconductor integrated circuits. These objects and their new characteristics will be made clear by the description of the present specification and accompanying drawings.

Typical constitutions among those to be disclosed in the present invention are briefly explained below. Similarity circuits, which receive input signals composed of multi-dimensional vectors corresponding to the spectrum envelope of speech inputs to be recognized and put out characteristics based on the self-organizing algorithm, calculate a distance for a dimension using a pair of neuron MOSFETs corresponding to each dimension in order to obtain distances between the above-mentioned multi-dimensional input vectors and pattern vectors prepared in advance for speech recognition, perform the clustering process by summing the currents that flow through each neuron MOSFET and forming a voltage signal that corresponds to the degree of similarity, supply the voltage signal to a matrix circuit for matrix operation in which capacitors corresponding to weighting operations are arranged in matrix, and perform the labeling process by outputting what is most similar to the patterns, prepared in advance among the matrix operation outputs, as the recognition result.

### BRIEF DESCRIPTION OF THE DRAWINGS

The features and advantages of the invention will be more clearly understood from the following description taken in conjunction with the accompanying drawings, in which:

FIG. 1 is a general structure diagram that shows an embodiment of the speech recognition device relating to the present invention.

FIG. 2 is a general signal processing flow chart that shows an embodiment in the speech recognition device relating to the present invention.

FIG. 3 is a general circuit diagram that shows an embodiment of the speech recognition device (clustering/labeling circuit) relating to the present invention.

FIG. 4 is a circuit diagram that shows an embodiment of the similarity circuit used in the present invention.

FIG. 5 is a diagram that illustrates the operation principles of the neuron MOSFET used in the present invention.

FIGS. 6A and 6B are circuit diagrams that illustrate how to operate the neuron MOSFET used in the present invention.

FIG. 7 is a circuit diagram that shows an embodiment of the operational amplifier circuit used in the present invention.

FIG. 8 is a circuit diagram that shows an embodiment of the C-matrix used in the present invention.

FIGS. 9A and 9B are circuit diagrams that illustrate how to operate the C-matrix circuit shown in FIG. 8.

FIG. 10 is a table that shows an embodiment of the capacitance values (fF) of the template values C1ij of the clustering layer when the five vowels are recognized by the speech recognition device relating to the present invention.

FIG. 11 is a table that shows an embodiment of the learning results of weight and the capacitance values (fF) of the C-matrix of the labeling layer when the five vowels are recognized by the speech recognition relating to the present invention.

FIG. 12 is a diagram that shows the waveforms of the simulation results when the five vowels are supplied to the speech recognition device relating to the present invention.

FIG. 13 is a diagram that shows the output waveforms of the simulation results when the five vowels are supplied to the speech recognition device relating to the present invention.

### DESCRIPTION OF THE PREFERRED EMBODIMENTS

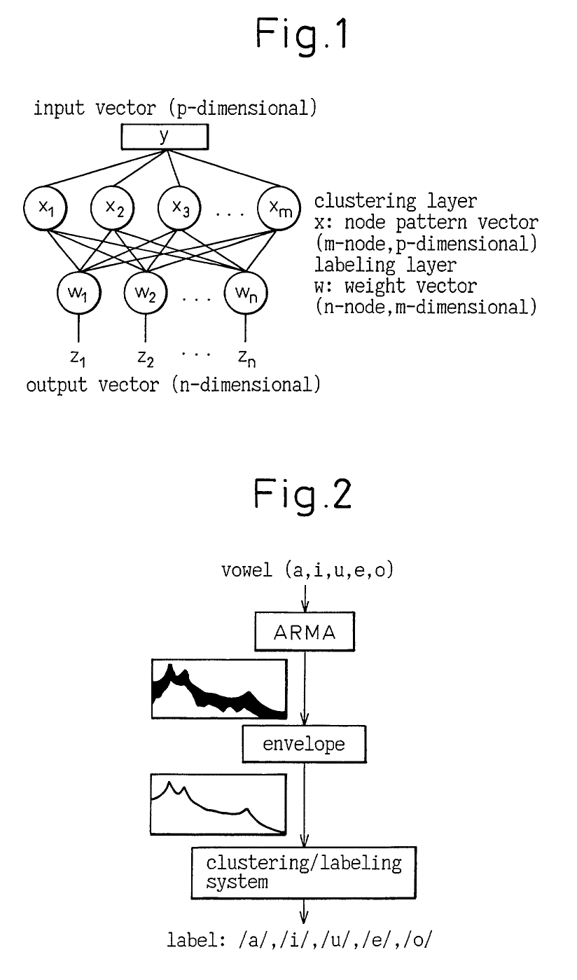

The general structure diagram of an embodiment of the speech recognition device relating to the present invention is shown in FIG. 1. The speech recognition system in this embodiment comprises two layers. The first layer, that is the clustering layer, puts out characteristics based on the self-organizing algorithm according to the input vector y consisting of p dimensions. The second layer, that is the labeling layer, receives the characteristic outputs formed in the first clustering layer, to which weights based on the teacher-attached algorithm are multiplied and summed. By the way, in the above-mentioned reference document 2, recognition and learning is carried out simultaneously in the same system as that shown in FIG. 1, but it is difficult to perform this in analog circuits.

In this embodiment, therefore, coefficients calculated in advance by a computer are embedded in a chip and the chip is made to only perform recognition using these values. Expressions used for recognition are shown below. There are m cluster nodes in the first layer and each node has a pattern vector xi (i=1, 2, . . . , m). Each node calculates the similarity Si (i=1, 2, . . . , m) based on the Euclidean distance Di (i=1, 2, . . . , m) between the p-dimensional input vector y=(y1, y2, . . . , yp) and the pattern vector xi =(xi 1, xi2, . . . , xip) as follows.

$$\begin{matrix}{D}_{i} \sqrt{{\sum }_{j = 1}^{P} {( {y}_{j} - {x}_{ij} )}^{2}} , & ( 1 ) \\ {S}_{i} = \{ \begin{matrix} 1 - {( {D}_{i} / {D}_{s} )}^{2} & {D}_{i} < {D}_{s} \\ 0 & {D}_{i} \geq {D}_{s}\end{matrix} & ( 2 )\end{matrix}$$

In expression 2, Ds is a threshold provided to deal with non-linear problems.

The second layer has n nodes and output Si of the first layer is multiplied by m-dimensional weight vector wt=(wt1, wt2, . . . , wtm) (t=1, 2, . . . , n) and summed. Output z=(z1, z2, . . . , zn) of the system is the sign.

$$\begin{matrix}{R}_{t} = {\sum }_{i = 1}^{m} {w}_{t i} {S}_{i} & ( 3 ) \\ {z}_{t} = \{ \begin{matrix}0 & {R}_{i} < 0 \\ 1 & {R}_{t} \geq 0\end{matrix} & ( 4 )\end{matrix}$$

The learning of the network is determined by configuring a software system that performs the identical operations and using the method described in the above-mentioned reference document 2. Although not restricted particularly in this embodiment, the component of xi is rounded to a whole number between 1 and 255 for hardware use and an appropriately rounded whole number is used for wt because of the limitations by the chip design rule.

The general signal processing flow chart in an embodiment of the speech recognition device relating to the present invention is shown in FIG. 2. Although not restricted particularly in this embodiment, circuits to recognize the five vowels a, i, u, e, and o are used for example in the following description.

The recognized speech input signal forms a signal consisting of multi-dimensional vector that corresponds to the spectrum envelope by the envelope processing after obtaining the frequency spectrum of the speech signal pitched in four levels using, for example, the linear predictive analysis method (ARMA speech analysis method), although not restricted particularly. From thus formed input signals, the speech recognition signals label: /a/, /i/, /u/, /e/, and /o/ are formed in the clustering/labeling circuit, which will be described below.

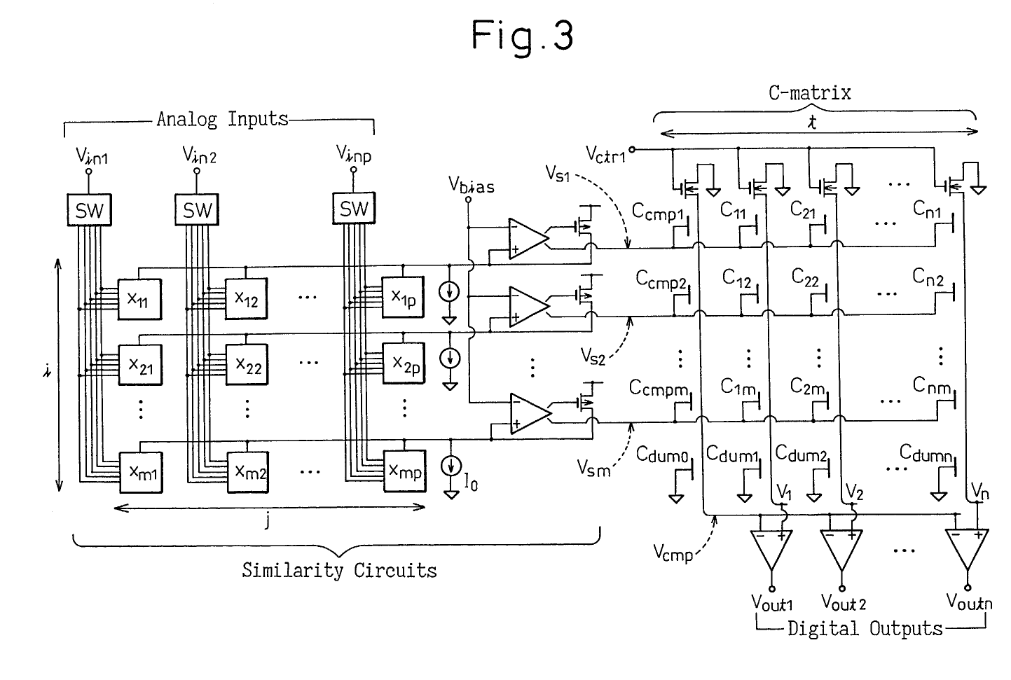

The general circuit diagram of an embodiment of the speech recognition device (clustering/labeling circuit) relating to the present invention is shown in FIG. 3. In the structure of this embodiment, m p-dimensional similarity circuits are arranged in parallel and n×m C (capacitor) matrix is attached to the outputs of these similarity circuits. In this figure, black boxes x11-xmp that constitute the similarity circuits are composed of pairs of neuron MOSFETs in the distance circuits. The components of the similarity circuit inputs are connected to each other, and input voltages are supplied to all the distance circuits simultaneously. The pattern vector Xi is memorized in each similarity circuit as a ratio of the capacitances and the result of the similarity operation is supplied to the C-matrix, then the weighting operation and sign discrimination are performed.

As described above, when the five vowels (a, i, u, e, o) are recognized, the black boxes x11 to xmp that constitute the similarity circuits in the embodiment are composed of 30×16 units. In other words, the input signals Vin1 to Vinp are set to the input signals Vin1 to Vin30 consisting of the 30-dimensional vectors that correspond to the spectrum envelope, and supplied to the pairs of neuron MOSFETs shown by the 16-black boxes in which the input signals Vin1 to Vin30 are arranged in the direction of column. By this, the output signals Vs1 to Vsm formed in the clustering layer are set to 16 signals such as Vs1 to Vs16.

In the C-matrix circuit, the 16 rows that correspond to the 16 output signals from the above-mentioned similarity circuits, the six columns, that is, the five columns that correspond to the five vowels (a, i, u, e, o) and the comparison capacitor column, and the dummy capacitor Cdum to equalize the total capacitance in each column, are provided. Therefore, in total, in the C-matrix, 17×6 capacitors are provided.

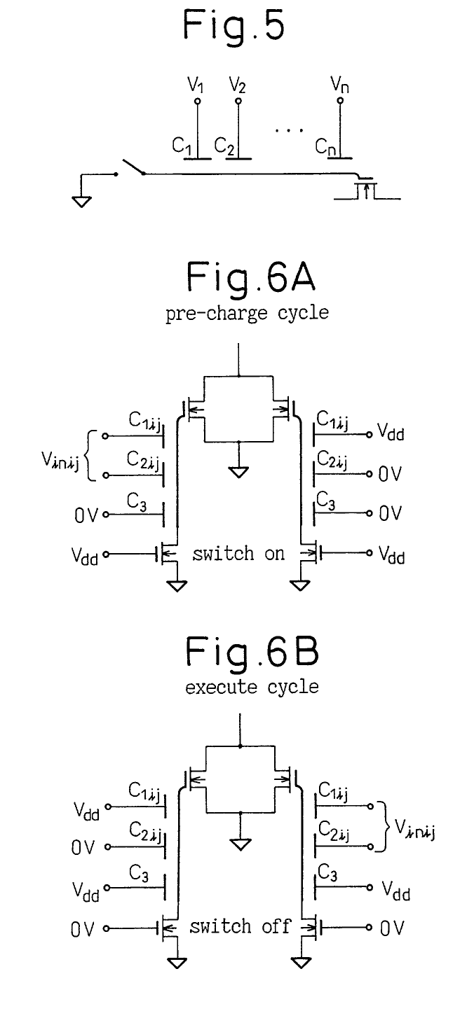

In this embodiment, the neuron MOSFETs are used for a subtractive operation to calculate distances in the similarity circuits (clustering circuit), as mentioned above. The diagram that illustrates the operation principles of the neuron MOSFET is shown in FIG. 5. To the gate of the neuron MOSFET, n inputs of capacitors are connected. According to the operation principles of the neuron MOSFET, Vi (i=1, 2, . . . , n) is applied to each input first and then the switch is closed to pre-charge 0V to the gate. Next, the switch is opened to terminate the pre-charge and the input voltage is changed to Vi′ (i=1, 2, . . . , n). The voltage applied to the gate of MOSFET at this time is as shown in expression 5.

$${V}_{gs} = \frac{{\sum }_{i = 1}^{n} {C}_{i} ( {V}_{i}^{′} - {V}_{i} )}{{C}_{a11}} \qquad ( 5 )$$

“Call” is the total capacitance of the capacitors attached to the gate.

The basic characteristic of the MOSFET used in the circuit in the embodiment is as follows. In the range Vthn<Vgsn<Vdsn+Vthn, the n-channel MOSFET operates in the saturation area and the relation between the drain current and the gate current is as shown in expression 6.

$${I}_{dsn} = \frac{{KP}_{n}}{2} {( {V}_{gsn} - {V}_{thn} )}^{2} \qquad ( 6 )$$

The p-channel MOSFET operates in the linear area (non-saturation area) in the range Vdsp+Vthp>Vgsp, as shown in expression 7.

$${I}_{dsp} = - K {P}_{p} \{ ( {V}_{gsp} - {V}_{thp} ) {V}_{dsp} - \frac{1}{2} {V}_{dsp}^{2} \} \qquad ( 7 )$$

In expressions 6 and 7, Vgsn, Vdsn, Vthn, KPn, and Idsn refer to the gate—source voltage, the drain—source voltage, the threshold voltage, the transconductance, and the drain current, respectively, of the n-channel MOSFET, and Vgsp, Vdsp, Vthp, KPp, and Idsp refer to the gate—source voltage, the drain—source voltage, the threshold voltage, the transconductance, and the drain current, respectively, of the p-channel MOSFET. In the present embodiment, the degree of similarity is calculated by combining the saturation area of the n-channel MOSFET and the linear area of the p-channel MOSFET, as described later.

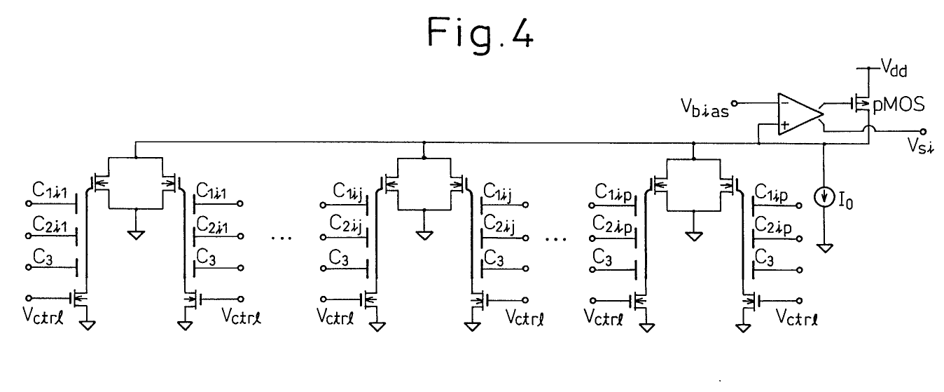

The circuit diagram of the similarity circuit in the embodiment used in the present invention is shown in FIG. 4. In the circuit of the present embodiment, a circuit, which calculates the distance between the p-dimensional input vector y=(y1, y2, . . . , yp) and the pattern vector xi=(xi1, xi2, . . . , xip), is schematically shown as a typical one. As described above, when the five vowels are recognized, similar circuits, 16 in total, are provided.

Although not restricted in particular, it is assumed that the components of the above-mentioned vectors y and xi are whole numbers between 0 and 255. In the present embodiment, the two neuron MOSFTEs calculate the value corresponding to one dimension. Each of the j-th pair of neuron MOSFETS has capacitance of C1ij, C2ij, and C3. C1ij and C2ij are determined using the j-th component xij of the pattern vector xi so as to have the ratio as shown in the following expression.

C₁ᵢⱼ:C₂ᵢⱼ=Xᵢⱼ:255−Xᵢⱼ (8)

C3 is set as shown in expression 9, being made to correspond to the threshold voltage of the n-channel MOSFET.

$${C}_{3} = {C}_{a11} \frac{{V}_{thn}}{{V}_{dd}} \qquad ( 9 )$$

“Call” is the total sum of capacitances of the capacitors attached to the gate, as in expression 5.

As the input voltage, the analog voltage Vinj for each element of the vector is given by expression 10.

$${V}_{inj} = \frac{{y}_{j}}{255} {V}_{dd} \qquad ( 10 )$$

The voltage of the node is kept equal to the voltage Vbias of the reversed input of the operational amplifier circuit, because all the outputs (drains) of the neuron MOSFET pairs are connected to each other and the node is provided with feedback from the operational amplifier circuit through the p-channel MOSFET. In other words, the operational amplifier circuit forms the output voltage so that the voltage Vbias given to the reversed input (−) becomes equal to the non-reversed input (+) voltage, that is, the voltage of the drain of the neuron MOSFET is equal to that of the drain of the p-channel MOSFET at the connection node and, then, it drives the p-channel MOSFET. It is possible, thereby, to establish the operation conditions with which the neuron MOSFET is driven in the saturation area and the p-channel MOSFET is driven in the linear area.

The circuit diagrams the illustrate the operation method of the neuron MOSFET are shown in FIG. 6A and FIG. 6B. FIG. 6A shows the pre-charge cycle, during which the n-channel MOSFET attached to the floating gate is turned on and a pre-charge is performed to the grounding voltage 0V of the circuit. During the pre-charge cycle, the capacitors C1ij and C2ij of the neuron MOSFET on the left-hand side are provided with the input voltage vinij, and the capacitor C3, with 0 V. On the contrary, the capacitor C1ij of the neuron MOSFET on the right-hand side is provided with Vdd and C2ij and C3, with 0 V.

FIG. 6B shows the execute cycle, during which the n-channel MOSFET attached to the above-mentioned floating gate is turned off and the capacitor C3 is provided with vdd. During the execute cycle, in contrast with the above-mentioned case, the capacitors C1ij and C2ij of the neuron MOSFET on the right-hand side are provided with the input voltage Vinij. On the contrary, the capacitor C1ij of the neuron MOSFET on the left-hand side is provided with Vdd, and C2ij, with 0 V. At this time, The voltage Vgsn (left) and Vgsn (right) between the gate and source of the left- and right-hand side neuron MOSFETs in the cell are obtained as expressions 11 and 12 by substituting expressions 8, 9, and 10 into expression 5.

$$\begin{matrix}{V}_{gsn ( left )} = {V}_{thn} - \frac{{C}_{0}}{{C}_{all}} \frac{( {y}_{j} - {x}_{ij} )}{255} {V}_{dd} , & ( 11 ) \\ {V}_{gsn ( right )} = {V}_{thn} + \frac{{C}_{0}}{{C}_{all}} \frac{( {y}_{j} - {x}_{ij} )}{255} {V}_{dd} , & ( 12 )\end{matrix}$$

Since either Vgsn (left) or Vgsn (right) in the above-mentioned expressions is smaller than Vthn, the drain current does not flow in such a case because of the cut off state. The drain current flows in the other MOSFET and if the gate voltage is smaller than Vbias+Vthn, expression 13 is obtained from expression 6

$${I}_{dsn} = \frac{{KP}_{n}}{2} {\{ \frac{{C}_{0}}{{C}_{all}} \frac{( {y}_{j} - {x}_{ij} )}{255} {V}_{dd} \}}^{2} \qquad ( 13 )$$

When the gate voltage exceeds Vbias +Vthn, expression 13 does not hold because the neuron MOSFET operates in the linear area. In the simulation that will be shown later, however, it does not matter even if the squared current cannot be obtained because the area moves to the area beyond the threshold Ds in expression 2.

Switching of the input signal Vinij as shown in FIG. 6A and FIG. 6B is performed by the switch circuit SW in FIG. 3. The capacitor C3 and the n-channel switch MOSFET are provided with the same operation signal. Therefore, in the circuit in FIG. 3, the circuit to control the capacitor C3 and the n-channel switch MOSFET is omitted.

In FIG. 4, since no current flows through the input of the operational amplifier circuit, all the drain current of the neuron MOSFET flows into the p-channel MOSFET. The current that flows in the p-channel MOSFET is the sum of the current of all the neuron MOSFETs in the same row, therefore, expression 14 is obtained.

$$- {I}_{dsp} = {\sum }_{j = 1}^{p} \frac{{KP}_{n}}{2} {\{ \frac{{C}_{0}}{{C}_{all}} \frac{( {y}_{j} - {x}_{ij} )}{255} {V}_{dd} \}}^{2} + {I}_{0} \qquad ( 14 )$$

Here, the constant current I₀, which is provided to the drain of the p-channel MOSFET, also serves to keep the feedback by conducting current to the p-channel MOSFET during the pre-charge cycle. On the other hand, feedback is applied to the p-channel MOSFET via the operational amplifier circuit, a gate voltage corresponding to the drain current that flows is applied to with the aid of the operational amplifier circuit, and the gate voltage is used as output.

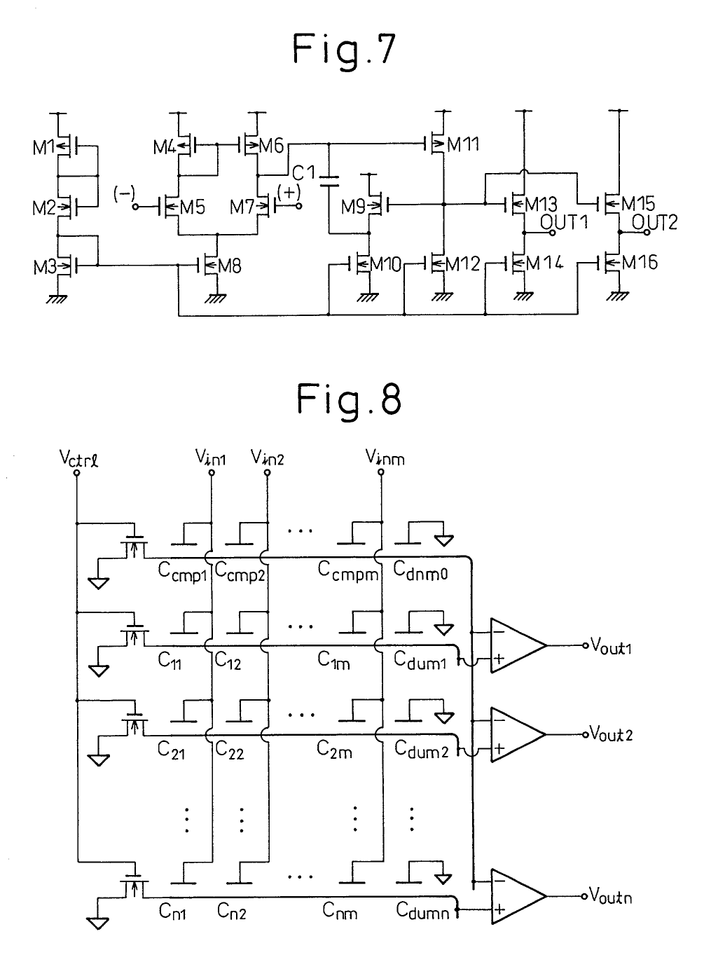

The circuit diagram of an embodiment of the above-mentioned operational amplifier circuit is shown in FIG. 7. The drains of the n-channel differential MOSFETs M5 and M7 are provided with a load circuit composed of the p-channel MOSFETs M4 and M5, which are arranged in the current mirror layout, and the source commonly connected to the above-mentioned MOSFETs M5 and M7 is provided with the n-channel current source MOSFET M8 that conducts the operation current. The output signal obtained from the drain of the above-mentioned differential MOSFET M7 is sent to the gate of the p-channel amplification MOSFET M11. The drain of the amplification MOSFET M11 is provided with the n-channel current source MOSFET M12 as a load.

The drain output of the amplification MOSFET M11 is commonly supplied to the gates of the n-channel source follower output MOSFETs M9, M13, and M15. The sources of the source follower output MOSFETs M9, M13, and M15 are provided with the n-channel current source MOSFETs M10, M14, and M16 as loads. The above-mentioned three source follower output circuits form output signals that are electrically separated and the source output of the output MOSFET M9, which is one of those mentioned above, constitutes the feedback circuit of the amplification MOSFET M11 and is connected to the phase compensation capacitor C1.

The other two output MOSFETs are connected to the output terminals OUT1 and OUT2, respectively, and the output terminal OUT1 is used to output the output voltage so that the voltage of the drain of the neuron MOSFET and that of drain of the p-channel MOSFET are equal at the connection node as mentioned above, although not restricted particularly. The output terminal OUT2 is used to form the signal Vsi to be supplied to the C-matrix, which is the circuit in the next stage. Oscillation caused by the capacitance of the C-matrix in the next stage can be thus avoided.

The circuit diagram of the C-matrix of an embodiment is shown in FIG. 8. The C-matrix circuit in the present embodiment has a structure in which capacitors are arranged in a matrix form and comparators are connected, and performs the operation to discriminate the sign of the results of the matrix operation as shown in expressions 15 and 16.

$$\begin{matrix}( \begin{matrix}{r}_{1} \\ {r}_{2} \\ ⋮ \\ {r}_{n}\end{matrix} ) = ( \begin{matrix}{w}_{11} & {w}_{12} & … & {w}_{1 m} \\ {w}_{21} & {w}_{22} & … & {w}_{2 m} \\ ⋮ & ⋮ & & ⋮ \\ {w}_{n1} & {w}_{n2} & … & {w}_{n m}\end{matrix} ) ( \begin{matrix}{s}_{1} \\ {s}_{2} \\ ⋮ \\ {s}_{m}\end{matrix} ) & ( 15 ) \\ {z}_{t} = \{ \begin{matrix}1 & {r}_{t} > 0 \\ 0 & {r}_{t} < 0\end{matrix} ( t = 1 , 2 , … , n ) & ( 16 )\end{matrix}$$

s=(s1, s2, . . . , sm)^{T} is an m-dimensional input vector the components of which are positive, and zt is the component of the n-dimensional output vector z=(z1, z2, . . . , zn)^{T}. The weighting matrix is an n×m matrix and the components wti can be negative or positive. The C-matrix has m comparison capacitors and the capacitance Ccmpi (i=1, 2, . . . , m) can be obtained by expressions 17 and 18.

$${C}_{c m p i} = \{ \begin{matrix}{C}_{0} & {W}_{{min}_{i}} \geq 0 \\ {C}_{0} - {C}_{W {min}_{i}} & {W}_{{min}_{i}} < 0\end{matrix} \qquad ( 17 )$$

Wₘᵢₙᵢ=min{W₁ᵢ, W₂ᵢ, . . . , Wₙᵢ} (18)

According to the design rules, C₀ in expression 17 is the minimum capacitance and C is a step of available capacitance. When the difference between the minimum value wmini and the second minimum w in the same column is equal to or more than C₀/C, C₀ can be ignored and the comparison capacitor is determined simply by expression 19.

$${C}_{c m p i} = \{ \begin{matrix}0 & {W}_{{min}_{i}} \geq 0 \\ - {C}_{W {min}_{i}} & {W}_{{min}_{i}} < 0\end{matrix} \qquad ( 19 )$$

Other capacitors Cti (t=1, 2, . . . , n) (i=1, 2, . . . , m) are determined by expression 20 using the value Ccmpi of the comparison capacitor.

Cₜᵢ=C_{Wti}+C_{cmpi} (20)

In addition, dummy capacitors Cdumt (t=1, 2, . . . , n) are provided so that the summed value of the capacitors in each row is equal to the same value Csum.

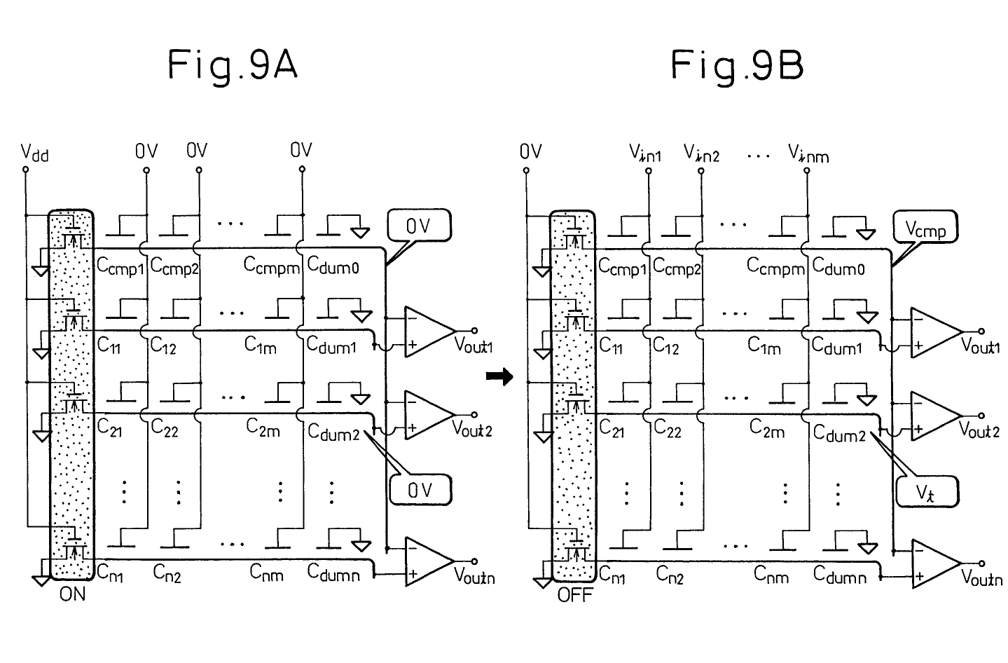

The circuit diagrams to illustrate the operation method of the C-matrix circuit are shown in FIG. 9A and FIG. 9B. In the operation method of the C-matrix circuit, all the MOSFET switches are turned on first, all the input voltages are set to 0 V, and the voltage of the floating node is pre-charged to 0 V, as shown in FIG. 9A. Then, as shown in FIG. 9B, all the MOSFETs are turned off to terminate the pre-charge and the input voltage Vini in proportion to each input component si is added. As a result, the potential of the comparison floating node is obtained as expression 21 and that of the t-th floating node is as expression 22.

$$\begin{matrix}{V}_{cmp} = \frac{{\sum }_{i = 1}^{m} {C}_{{cmp}_{i}} {V}_{{in}_{i}}}{{C}_{sum}} & ( 21 ) \\ {V}_{t} = \frac{{\sum }_{i = 1}^{m} {C}_{Wti} {V}_{ini} + {\sum }_{i = 1}^{m} {C}_{{cmp}_{i}} {V}_{{in}_{i}}}{{C}_{sum}} & ( 22 )\end{matrix}$$

If it is assumed that the output of the t-th comparator that compares these two potentials is Vdd, expression 23 is required because Vcmp<Vt, and it is found that this is the same operation as those shown by the above-mentioned expressions 15 and 16.

$${\sum }_{i = 0}^{m} {C}_{Wti} {V}_{ini} > 0 \qquad ( 23 )$$

Since the speech recognition device relating to the present invention has the object to be applied to speech recognition, the spectrum envelopes of five vowels expressed in a feminine voicels are used as inputs to the present circuit. More concretely, the 30-dimensional vectors, each component of which is a rounded whole number from 1 to 255, are used. As a result of learning, the scale of this circuit is p=30, m=15, and n=5 in the FIG. 3. The circuit has been designed based on the values of the pattern vectors and weight vectors obtained from this learning.

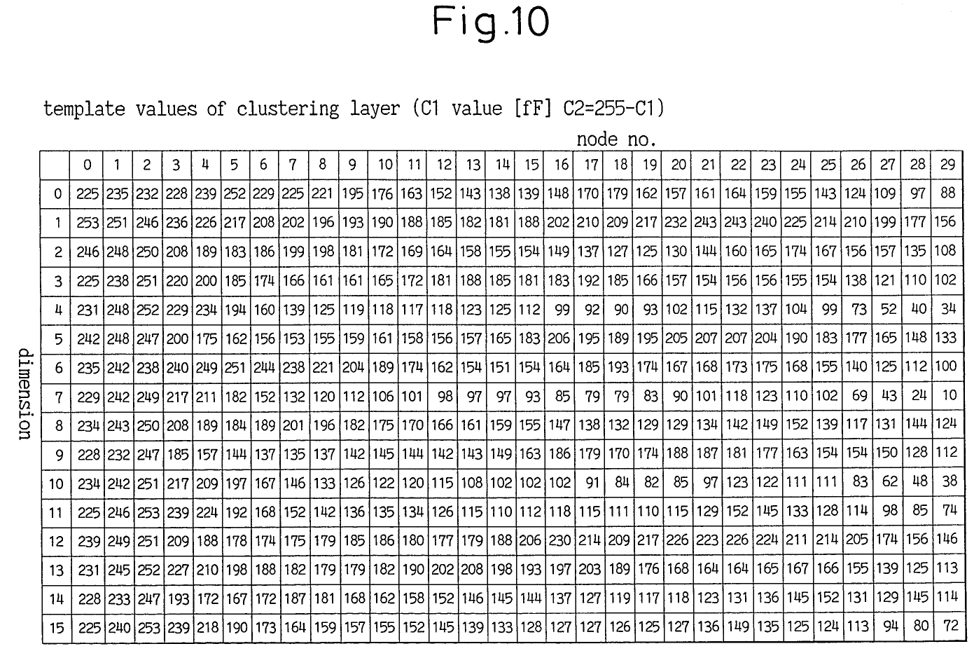

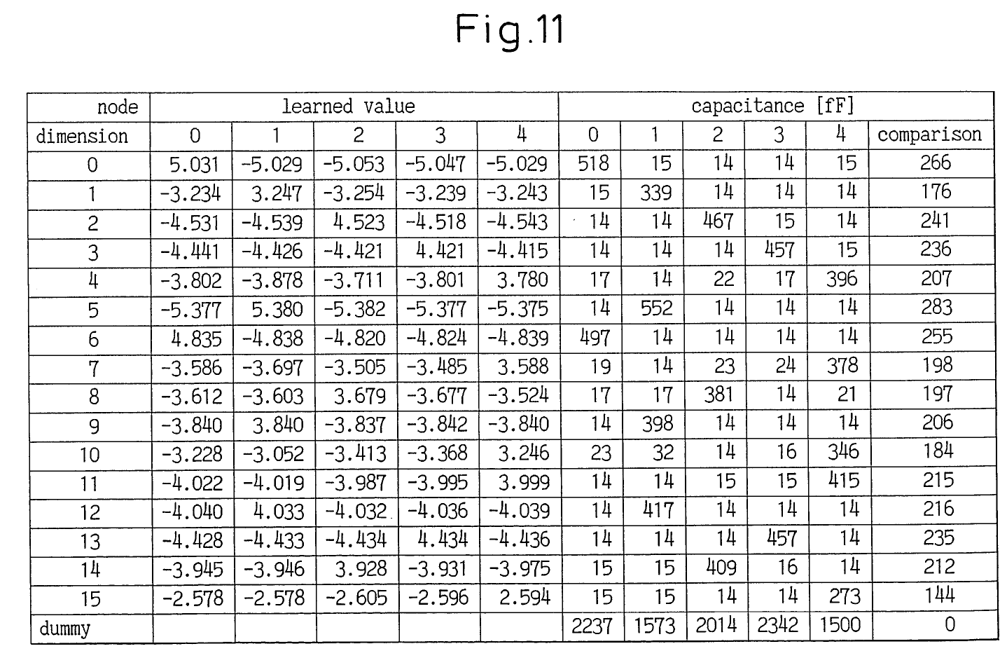

In FIG. 10, examples of the capacitance (fF) of the template value C1ij of the clustering layer when the five vowels (a, i, u, e, o) are recognized as mentioned above are shown. Capacitance C2ij is obtained by C2ij=255−C1ij. The node number corresponds to the 30-dimensional vector that corresponds to the above-mentioned spectrum envelope.

In FIG. 11, examples of learned results of weight and the capacitance (fF) of C-matrix of the labeling layer when the five vowels (a, i, u, e, o) are recognized as mentioned above are shown.

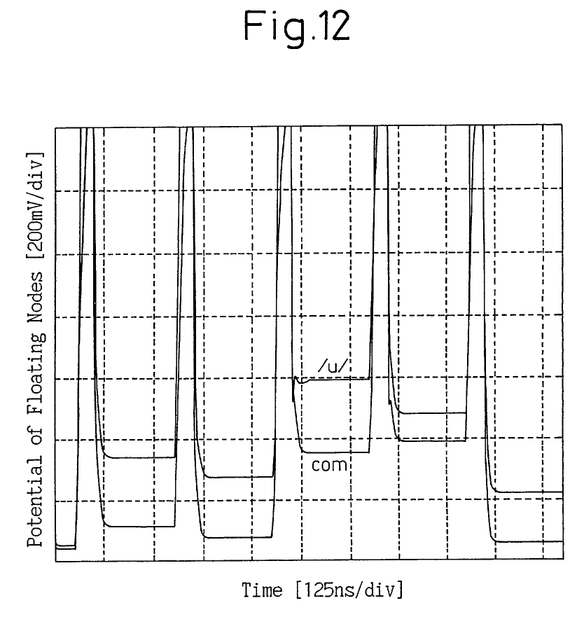

The results of the simulation are shown in FIG. 12, when the clustering layer and the labeling layer of a speech recognition device are configured in the above-mentioned structure and the five vowels (a, i, u, e, o) are entered. In the figure, the potentials of the comparison floating nodes that recognize /u/ of the C-matrix are shown. When a, i, u, e, and o are entered into the input in this order, the potential of the floating node is raised compared to the comparison com only for the input /u/ and a high level output signal Vout3 is output from the voltage comparison circuit.

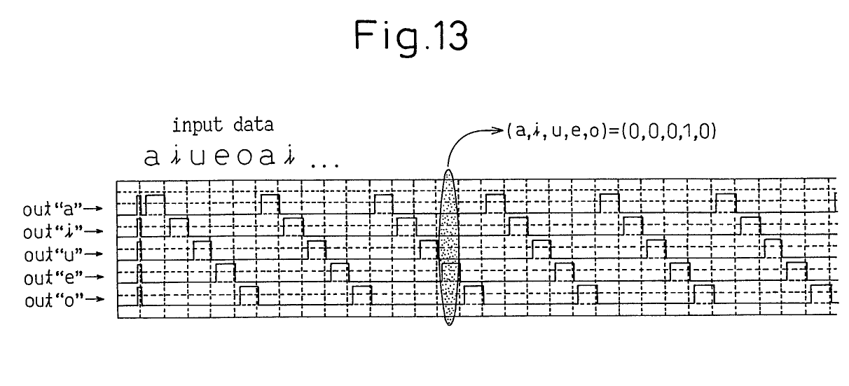

In FIG. 13, the output waveforms of the simulation result are shown, when the clustering layer and the labeling layer of the speech recognition device are configured as that in the above-mentioned structure and the five vowels (a, i, u, e, o) are entered. When a, i, u, e, and o are entered repeatedly in this order as input data, the output out “a”, out “i”, out “u”, out “e”, and out “o” are put out in this order. If the input data pointed by the arrow is assumed to be e, for example, the outputs out “a” to out “o” are put out as a digital signal with a pattern 0, 0, 0, 1, 0.

The speech recognition device relating to the present invention is designed with a clustering system of two inputs, four nodes and two outputs in accordance with the 1.5 μm rule. In order to digitize the input, the neuron MOSFET is made to have five inputs, and the ratio of the capacitances of four of them is designed to be 1:2:4:8 to play a role of a simple digital/analog conversion. The chip area required for this design is 537,000 μm².

In order to compare to the speech recognition device in the analog circuit structure relating to the present invention, designing with an 8-bit digital circuit is also carried out. In designing, the hardware description language Verilog-HDL is used. All operations are designed so as to be performed in parallel, similarly to the case of the analog circuit. The area required for this is 19,516,000 μm². This indicates that the area can be reduced to one thirty-sixth, compared to that of the 8-bit digital circuit, if the above-mentioned analog circuit is used.

Although the larger the scale, the larger the chip area for wiring is required in a digital circuit, the larger the scale, the more advantage in area can be obtained in the speech recognition device of the present invention because of the structure in which the basic operation circuits are arranged in order.

Since the current/voltage characteristics of a MOSFET are used without modification in the speech recognition device relating to the present invention, a statistical analysis has been carried out in order to investigate how the variations in devices affect the cluster processing. The threshold voltages Vthn and Vthp of the n-channel MOSFET and the p-channel MOSFET are set based on a normal distribution with a standard deviation provided that σ=0.1V, and the transconductance KPn and KPp, provided that σ=10%, being independent parameters.

The amplifier circuit is designed using about 10 MOSFETs and it is assumed that these are arranged in a small area and the variations are small, then a set of Vthn, Vthp, KPn, and KPp is determined to be used as a typical value of the MOSFET in the amplifier circuit. Although capacitors are designed in accomplice with the limitations of the design rule that the minimum capacitance is 14 fF and the step is 1 fF, they are varied at a ratio of σ=1 fF regardless of capacitance. With these conditions, a set of data (a, i, u, e, o) is entered and a Monte-Carlo simulation is carried out 30 times. As a result, it is found that precise operations are ensured due to the redundancy of clustering even if there exist errors in the devices.

Although the present invention is described with reference to embodiments as above, it is obvious that the present invention is not restricted to the above-mentioned embodiments and various modifications are available without deviating from the concept. For example, it is an acceptable case in which the comparison capacitor is omitted in the C-matrix, a voltage follower circuit is provided at the output to put out the matrix operation outputs, and a level discriminating circuit to select the largest one among them is provided.

When consonants, voiced sounds, and semivoiced sounds are recognized in addition to the above-mentioned vowels, clustering layers using the above-mentioned neuron MOSFET or labeling layers using the C-matrix are provided in accordance with them. In this case, the multi-dimensional vector corresponding to the spectrum envelope of input is common to all the circuits and the input capacitance of the clustering layer becomes large. It is recommended, therefore, to divide the clustering layer into plural circuits and provide an input buffer circuit corresponding to each circuit. The present invention can be widely used as a speech recognition device composed of semiconductor integrated circuits.

The effects obtained from the typical examples of the present invention are briefly described below. The similarity circuits, which receive input signals composed of multi-dimensional vectors corresponding to the spectrum envelope of speech inputs to be recognized and put out characteristics based on the self-organizing algorithm, calculate a distance for a dimension using a pair of neuron MOSFETs corresponding to each dimension in order to obtain the distance between the above-mentioned multi-dimensional input vectors and the pattern vectors prepared in advance for speech recognition, perform the clustering process by summing current that flows through each neuron MOSFET and forming a voltage signal that corresponds to the degree of similarity, supply the voltage signal to a matrix circuit for matrix operation in which capacitors corresponding to weighting operations are arranged in matrix, and perform the labeling process by putting out what is most similar to the patterns prepared in advance among the matrix operation outputs as the recognition result. Therefore, speech recognition can be realized in a small-scale circuit.

We claim:

1. A speech recognition device, comprising a similarity circuit that receives input signals composed of multi-dimensional vectors corresponding to the spectrum envelope of speech inputs to be recognized and puts out characteristics based on the self-organizing algorithm, and a matrix circuit that performs matrix operations of the output signals of said similarity circuit, wherein said similarity circuit comprises a circuit to calculate a distance between said multi-dimensional input vector and a pattern vector prepared in advance for speech recognition, calculates a value corresponding to one dimension using a pair of neuron MOSFETs for each dimension, and forms a voltage signal in accordance with the degree of similarity by summing the current that flows through each neuron MOSFET; and said matrix circuit, in which capacitors corresponding to weighing operations are arranged in matrix, receives the voltage signal in accordance with said degree of similarity and puts out what is most similar to said patterns prepared in advance from among the matrix operation results as the recognition result.

2. A speech recognition device, as set forth in claim 1, wherein said two neuron MOSFETs are of n-channel type and the drains of neuron MOSFETs for plural dimensions corresponding to the spectrum envelope of speech input are connected commonly to sum the drain current; said summed drain current is made to flow into a p-channel MOSFET that converts the drain current into a voltage signal; the connection node, to which the drain of said p-channel MOSFET and the drains of the neuron MOSFETs commonly connected are connected, is connected to one of inputs of an operational amplifier circuit; the output voltage of said operational amplifier circuit is supplied to the gate of said p-channel MOSFET; and the other input of said operational amplifier circuit is provided with an bias voltage that operates said neuron MOSFET in a saturation area and said p-channel MOSFET, in a non-saturation area.

3. A speech recognition device, as set forth in claim 2, wherein said operational amplifier circuit has a common input and comprises a first and a second source follower output circuit having an identical circuit constant; the output signal of said first source follower output circuit is supplied to the gate of said p-channel MOSFET; and the output signal of said second source follower output circuit is supplied to said matrix circuit as an input voltage.

4. A speech recognition device, as set forth in claim 2, wherein dummy capacitances are added to said matrix circuit if necessary to equalize the input capacitance of plural input terminals to each other.

5. A speech recognition device, as set forth in claim 4, wherein said matrix circuit is provided with a comparison capacitor in accordance with an input signal; plural voltage comparison circuits, which regard the voltage formed by said comparison capacitor as a reference voltage and correspond to the speech recognition outputs that receive each matrix operation output, respectively, are provided; and a speech recognition output is obtained from each voltage comparison circuit.

6. A speech recognition device, as set forth in claim 1, wherein each of said circuit blocks is formed on a substrate that constitutes an integrated circuit.

7. A speech recognition device, as set forth in claim 2, wherein each of said circuit blocks is formed on a substrate that constitutes an integrated circuit.

8. A speech recognition device, as set forth in claim 3, wherein each of said circuit blocks is formed on a substrate that constitutes an integrated circuit.

9. A speech recognition device, as set forth in claim 4, wherein each of said circuit blocks is formed on a substrate that constitutes an integrated circuit.

10. A speech recognition device, as set forth in claim 5, wherein each of said circuit blocks is formed on a substrate that constitutes an integrated circuit.
